(19) United States
(12) Patent Application Publication
(10) Pub. No.: US 2004/0076307 A1
(43) Pub. Date: Apr. 22, 2004

(54) Twin magnetic loop used in the electro-acoustic device

(75) Inventors: Zheng Min Pan, La Verne, CA (US); Jiazheng Sha, La Verne, CA (US); Pan Da Sheng, Shenzhen City (CN)

Correspondence Address: BIRCH STEWART KOLASCH & BIRCH, PO BOX 747, FALLS CHURCH, VA, 22040-0747, US

(73) Assignee: American Audio Components, Inc., La Verne, CA

(21) Appl. No.: 10/271,752

(22) Filed: Oct. 17, 2002

(51) Int. Cl. H04R 1/00; H04R 9/06; H04R 11/02

(52) U.S. Cl. 381/412; 381/396

(57) ABSTRACT

A novel electromagnetic acoustic device with twin magnetic loops is disclosed. The electro-acoustic device of the present invention comprises a magnetic transfer, a magnetic column (2), an annular magnet (4), an annular pole piece (5) and a pole piece (3). The magnetic transfer comprises a first, “cup-shaped”, round housing (11, 12) and its flange (13), which is the second annular. The first round housing (11, 12), the magnetic column (2), the pole piece (3) form the first magnetic loop. On the other side of the round housing, the housing flange, the annular magnet (4) and the annular pole piece (5) form the second magnetic loop.

### FIELD OF THE INVENTION

This patent application relates to audio transducers, and more particularly to electromagnetic acoustic devices for use with portable and hand-held electronics products.

### BACKGROUND OF THE INVENTION

It is quite common to use audio transducers in electronic devices to convert an electrical signal input into sound by producing an acoustic output in response to the input signal. The application of such audio transducers, commonly known in the art as “buzzers”, can be found in automobile dashboard electronics, appliances and portable electronic products. Particularly with portable devices, such audio transducers are required to be both reliable and compact. Such requirements are mostly likely demanded in the field of portable electronic devices, such as cell phones, PDA or pagers. A buzzer on the cell phone generates the ringing or the keystroke tone, in response to the respective electrical signals.

A conventional electro-dynamic or electromagnetic acoustic device typically uses a single magnetic loop as its essential component, largely because the single-loop electro-acoustic device only needs to achieve a single function. There are two general kinds of single magnetic loop: an outer magnetic loop and an inner magnetic loop. Conventionally, the outer magnetic loop has a T-shaped iron material, an annular magnet and an annular pole piece, forming a closed magnetic circuit. The inner magnetic loop has a magnetic transfer, a magnet and a pole piece, forming a closed magnetic circuit. A voice coil with either of the two magnetic loops constitutes the driving system, with which a vibrating membrane (or a paper cone) forms the vibrating system. With a shell assembled on them, a conventional acoustic product is thus produced.

Recently, however, an electronics product often is required to contain several audio components. For example, in a mobile phone, there may be a ringer, a receiver and a hands-free speaker. In this case, more than one audio component is needed, even as the mobile phones are gradually shrinking in size. Therefore, integrating multiple functions into one product will help reduce the overall dimension of the product, as well as increase capacity and introduce cost-savings.

One of the objects of the present invention is to provide an electro-acoustic device with multiple audio functionality, which will enable the device to perform more functions while remaining compact in size.

### SUMMARY OF THE INVENTION

A novel electro-acoustic device with twin magnetic loop is disclosed. The electro-acoustic device of the present invention comprises a magnetic transfer, a magnetic column (2), an annular magnet (4), a first annular pole piece (5) and a pole piece (3). The magnetic transfer comprises a first, “cup-shaped”, round housing (11, 12) and its flange (13), which is the second annular pole piece. The first round housing (11, 12), the magnetic column (2), the pole piece (3) form the first magnetic loop. On the other side, or the “flip” side, of the round housing, the second annular pole piece (13), the annular magnet (4) and the annular pole piece (5) form the second magnetic loop.

In one embodiment of the present invention, the first round housing of the magnetic transfer is a round-body housing with a magnetic column in its center. The housing has an annular flange (13), or annular rim. A NbFeB (or Alnico) column (2) is set on the center of the concave housing, with the pole piece (3) placed thereon. The concave housing, the pole piece and the NbFeB (or Alnico) column form the first magnetic loop. The first voice coil is placed in the air gap (14).

On the other face of the round housing and the flange, a second part of the magnetic loop is formed with an annular magnet (4) fixed thereon. An annular pole piece (5) is placed above the annular magnet.

### BRIEF DESCRIPTION OF THE DRAWING

FIG. 1 is the sectional drawing of the configuration of an exemplary twin loop electro-acoustic device in accordance with one embodiment of the present invention.

FIGS. 2(a) and 2(b) are the perspective drawings of an exemplary configuration of a twin loop acoustic device in accordance with one embodiment of the present invention.

### DETAILED DESCRIPTION OF THE DRAWING

A novel electro-acoustic device with twin magnetic loops is disclosed. In the description that follows, various components, structures and method of manufacturing are described in general terms. As can be appreciated by those skilled in the art, this to facilitate the understanding of the invention, without unnecessarily obscuring the invention.

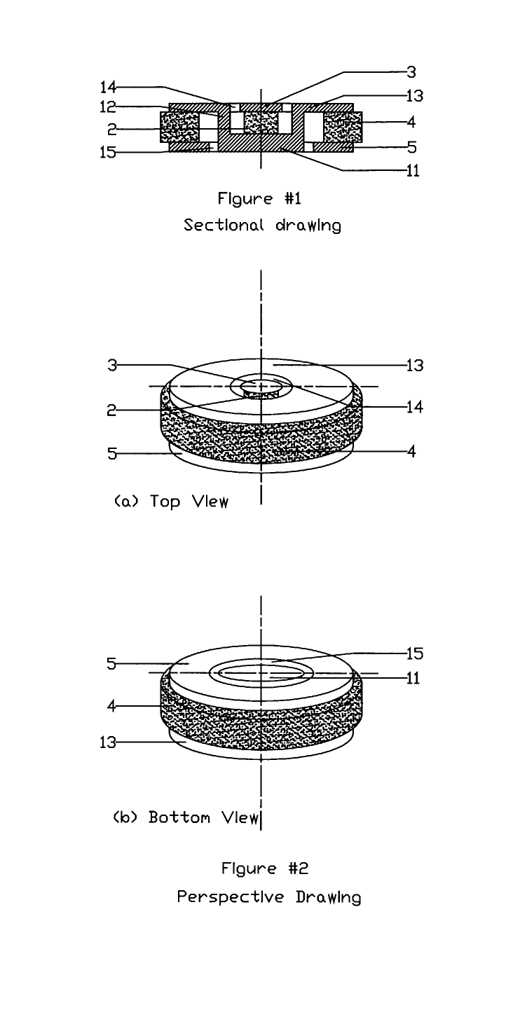

Reference is turned to FIG. 1, where a sectional drawing of an exemplary twin loop electro-acoustic device is illustrated. One embodiment of the electro-acoustic device in accordance with the present invention comprises a magnetic transfer, a magnetic column (2) placed within the cavity of the magnetic transfer, an annular magnet (4) surrounding the outside of the magnetic transfer's cavity at the other side, a pole piece (3) placed on the outward face of the magnetic column, and an annular pole piece (5) placed on the outward face of the annular magnet. Preferably, the magnetic column (2) may be implemented with composite magnetic material, such as NbFeB and Alnico. The annular magnet (4) may be implemented with composite magnetic materials such as BaFe₁₂O₁₉ and SrFe₁₂O₁₉.

The magnetic transfer is formed by a first housing (11, 12) and its extended annular flange (13). The first housing (11,12) has a round body with a cylindrical concave housing, or cavity, in its center. It is essentially a “cup-shaped” housing with an extended flange at its rim. A NbFeB (or Alnico) column (2) is placed in the center of the concave housing, and a pole piece (3) is on the outward face, or upper side, of the NbFeB (or Alnico) column (2).

The bottom (11) and waist (12) portions of the concave housing (the “cup”), the pole piece (3), and the NbFeB (or Alnico) column (2) constitute the first magnetic loop. Then a first voice coil (not shown) is placed in the air gap (14). On the other face of the housing (1 1, 12), the annular magnet (4) is placed underneath the extended annular flange (13) on the other side of the magnetic transfer. An annular pole piece (5) is placed on the outward face of the annular magnet (4), sandwiching, with the flange (13), the annular magnet (4). The extended annular flange (13), the annular magnet (4), the annular pole piece (5) thus form the second magnetic loop, with the second voice coil (not shown) being placed in the other air gap (15).

In comparison with the conventional electromagnetic acoustic devices, the twin loop device of the present invention has many advantages such as simple and compact construction, smaller volume, and cost- and material-savings.

FIGS. 2(a) and (b) illustrate the top and bottom perspective views of an exemplary electromagnetic acoustic device. The magnetic column (2) is placed inside the concave opening of the housing (11, 12), and topped by a pole piece (3). The annular magnet (4) surrounds the waist of the housing (11, 12) from the outside and under the flange (13). The annular magnet (4) is sandwiched between an annular pole piece (5) and the flange (13).

The present invention may be embodied in other specific forms without departing from the spirit or essential characteristics thereof. The present embodiments are to be considered in all respects as illustrative, and not restrictive. The scope of the invention is, therefore, indicated by the appended claims rather than by the foregoing description, and all changes, which come within the meaning and range of equivalency of the claims, are to be embraced within their scope.

What is claimed is:

1. An electromagnetic acoustic device, comprising:
a magnetic transfer, comprising:
a first round housing having a rim and a substantially cylindrical concave opening in its middle on a first face of said round housing;
an annular flange extending from said rim of said first round housing;
a magnetic column disposed in said concave opening;
a magnetic annular disposed on said annular flange and on a second face of said round housing;
an annular pole piece disposed on an outward face of said annular magnetic on said second face of said round housing;
a pole piece disposed on an outward face of said magnetic column;
a first coil being placed in an air gap between said pole piece and said first round housing on said first face of said round housing;
a second coil placed in an air gap between said annular pole piece and said first round housing on a second face of said round housing;
wherein said first round housing, said magnetic column, said pole piece form a first magnetic loop,
wherein said annular flange, said round housing and said annular magnetic form a second magnetic loop.

2. The device of claim 1, wherein said concave opening has a bottom portion which is integrally connected with the extended annular flange.

3. The device of claim 2, wherein said magnetic column is made of NbFeB composite material.

4. The device of claim 2, wherein said magnetic column is made of Alnico composite material.

5. An electromagnetic acoustic device, comprising:
a cup-shaped magnetic transfer housing, said cup-shaped magnetic transfer housing having an annular flange extending from a rim of said cup-shaped housing;
a magnetic column placed in said cup-shaped housing;
an annular magnet disposed underneath said annular flange; an annular pole piece disposed on an outward face of said annular magnet, such that said annular flange and said annular pole piece sandwich said annular magnet in-between;
a pole piece disposed on an outward face of said magnetic column;
a first coil disposed in an air gap between said pole piece and said cup-shaped housing;
a second coil disposed in an air gap between said annular pole piece and said round housing;
wherein said cup-shaped housing, said magnetic column, said pole piece form a first magnetic loop,
wherein said extended annular flange, said annular magnet and said annular pole piece form a second magnetic loop.

6. The electromagnetic acoustic device of claim 5, wherein said magnetic column is made of composite magnetic material such as NbFeB or Alnico.

7. The electromagnetic acoustic device of claim 5, wherein said annular magnet is made of composite magnetic material such as ferroxdure and strontian ferrite whose components are BaFe₁₂O₁₉ and SrFe₁₂O₁₉ respectively.

8. An electromagnetic acoustic device, comprising:
an annular magnetic transfer having a first and a second face, said first face having a generally cylindrical cavity in its center, said cavity having a flange extending from its rim, said second face having a waist and bottom portion of said cavity protruding therefrom;
a magnetic column placed in said cavity;
a pole piece placed on an outward face of said magnetic column;
a first air gap formed between said pole piece and said flange;
an annular magnet placed on said flange on said second face of said magnetic transfer;
an annular pole piece placed on an outward face of said annular magnet, said annular pole piece and said flange sandwiching said annular magnet in-between;
a second air gap formed between said bottom of said housing and said annular pole piece;
a first voice coil placed in said first air gap;
a second voice coil placed in said second air gap.

9. The electromagnetic acoustic device of claim 8, wherein said magnetic column is made of NbFeB or AlNiCo composite magnetic material.

10. The electromagnetic acoustic device of claim 8, wherein said annular magnetic is made of composite magnetic material such as ferroxdure and strontian ferrite whose main components are BaFe₁₂O₁₉ and SrFe₁₂O₁₉ respectively.
